(19) United States
(12) Patent Application Publication
(10) Pub. No.: US 2020/0118285 A1
(43) Pub. Date: Apr. 16, 2020

(54) DEVICE AND METHOD FOR DETERMINING HEIGHT INFORMATION OF AN OBJECT IN AN ENVIRONMENT OF A VEHICLE

(71) Applicant: ZF Friedrichshafen AG, Friedrichshafen (DE)

(72) Inventors: Jannik METZNER, Friedrichshafen (DE); Daniel FAFULA, Friedrichshafen (DE); Florian MAILE, Friedrichshafen (DE)

(73) Assignee: ZF Friedrichshafen AG, Friedrichshafen (DE)

(21) Appl. No.: 16/586,350

(22) Filed: Sep. 27, 2019

(30) Foreign Application Priority Data
Oct. 10, 2018 (DE) 102018217268.4

(51) Int. Cl. G06T 7/60; G06T 11/20; G06T 7/73; G01S 13/89; G01S 17/89; G01S 15/89

(52) U.S. Cl. CPC G06T 7/60; G06T 11/206; G06T 7/74; G01S 13/89; G06T 2207/30252; G01S 15/89; G06T 2207/10028; G06T 2207/10044; G01S 17/89

(57) ABSTRACT

A device for determining height information for an object in a vehicle environment comprises: an input interface for receiving environment sensor data from an environment sensor containing information regarding an object in the vehicle environment and vehicle sensor data from a vehicle sensor containing information regarding a movement of the vehicle in relation to the environment, a grid unit for generating a three dimensional grid display of the vehicle environment based on the environment sensor data and vehicle sensor data, an evaluation unit for detecting a reference plane in the three dimensional grid display, and a plotting unit for calculating a two dimensional vertical grid display of the vehicle environment based on the three dimensional grid display and the reference plane, wherein a grid cell in the two dimensional vertical grid display comprises height information for the object in relation to the reference plane.

### RELATED APPLICATIONS

This application claims priority from German Patent Application DE 10 2018 217 268.4, filed Oct. 10, 2018, the entirety of which is hereby incorporated by reference herein.

### TECHNICAL FIELD

The present invention relates to a device for determining height information of an object in an environment of a vehicle, and a corresponding method. The invention also relates to a system for determining height information of an object.

### BACKGROUND

Modern vehicles (cars, vans, trucks, motorcycles, etc.) comprise numerous driver assistance systems that provide information to the driver and control functions of the vehicle in a partially or fully automated manner. Sensors record the environment of the vehicle and other road users. A model of the vehicle environment can be generated, based on the recorded data. As a result of the progressive development in the field of autonomous and semi-autonomous vehicles, the effects and scope of action of driver assistance systems continue to grow. It is possible to record the environment and traffic and control the individual functions of the vehicle, entirely or partially, through the development of increasingly more precise sensors, without intervention from the driver. Driver assistance systems can contribute in particular to increasing safety in traffic and improving driving comfort.

An important prerequisite for this is the recording and perception of the environment of the actual vehicle. Sensor data with information regarding the environment is acquired by means of environment sensors, e.g. radar, lidar, ultrasound, and camera sensors. Objects in the environment of the vehicle can be identified and classified on the basis of the acquired data and taking into account any data available in the vehicle. The behavior of an autonomous or semi-autonomous vehicle can be adapted to a current situation based on the perceived object.

One challenge for recording the environment is the estimation of the ground surface or the surface of the street (road plane) in the field of view of the environment sensor. Sensors in vehicles present data in a relative or vehicle-based coordinate system (EGO coordinate system), relating to the vehicle in question. It is not possible to determine the heights of objects in relation to the ground surface or the roadway in such a coordinate system, in order to decide whether it is possible to drive over or under an object. A depiction and processing of the environment in a global or stationary coordinate system (global coordinate system) requires a complicated transformation. The decision regarding whether it is possible to drive over or under an object is relevant in many driving situations, however, and must take place more or less in real time.

### SUMMARY

Based on this, the present invention addresses the problem of providing an approach to determining height information regarding stationary and moving objects in a vehicle environment. In particular, this should enable a reliable and efficient calculation of object heights and unoccupied heights, i.e. the heights of empty regions beneath obstructions (e.g. bridges, etc.).

In order to solve this problem, the present invention relates to a device for determining height information regarding an object in a vehicle environment, comprising:

an input interface for receiving environment sensor data from an environment sensor containing information regarding objects in a vehicle environment, and vehicle sensor data from a vehicle sensor containing information regarding movement of the vehicle in relation to the environment;
a grid unit for generating a three dimensional grid display of the vehicle environment based on the environment sensor data and the vehicle sensor data;
an evaluation unit for detecting a reference plane in the three dimensional grid display; and
a plotting unit for calculating a two dimensional vertical grid display of the vehicle environment based on the three dimensional grid display and the reference plane, wherein a grid cell of the two dimensional vertical grid display comprises height information for the object in relation to the reference plane.

Furthermore, one aspect of the invention relates to a system for determining height information regarding an object in a vehicle environment, comprising: a device, as described above;

an environment sensor for detecting objects in a vehicle environment; and a vehicle sensor for detecting movement of the vehicle in relation to its environment.

Further aspects of the invention relate to a method corresponding to device, and a computer program product containing program code for executing the steps of the method when the program is executed on a computer, and a memory on which a computer program is stored that executes the method described herein when it is executed on a computer.

Preferred embodiments of the invention are described in the dependent claims. It is to be understood that the aforementioned features, and those described below, can be used not only in the respective given combinations, but also in other combinations or in and of themselves, without abandoning the framework of the invention. In particular, the system and the method, or computer program product, can be executed in accordance with embodiments of the device described in the dependent claims.

According to the invention, it is intended that sensor data from an environment sensor and sensor data from a vehicle sensor are processed. First, the sensor data from an environment sensor are plotted on a three dimensional grid display. When the three dimensional grid display is generated, the vehicle sensor data are taken into account, such that it is possible to use and correctly plot data from the environment sensor over a longer period of time, even when the vehicle continues to move while collecting data. A reference plane is determined on the basis of the three dimensional grid display that has been generated. The reference plane represents a ground surface, in particular a road surface (road plane estimation). Based on the determined reference plane, and taking the three dimensional grid display into account, a vertical grid display is created, in which height information regarding objects in the vehicle environment is determined in relation to the reference plane. Height information can comprise the height of an object and/or the height of an unoccupied space, in particular. The height of an object corresponds to the height above the ground or the road surface. An unoccupied height refers to a height in an unoccupied region, i.e. a height under which the vehicle can pass, e.g. a bridge.

Data from the environment sensor present in a coordinate system of the vehicle (EGO coordinate system) are thus used for determining height information in an absolute coordinate system (global coordinate system). This height information can represent a basis for controlling semi-autonomous or autonomous vehicles. In particular, it is possible to determine whether an object in a vehicle environment can be driven over or under. By way of example, it is possible to determine whether the surface of a road, or a road surface, allows for the vehicle to drive over an object that has been detected.

In comparison with prior approaches, the present invention represents an alternative approach for determining a reference plane and for deriving height information for objects in a vehicle environment. Portions of the stationary vehicle environment can be reliably and precisely perceived. An efficient calculation is obtained with the two dimensional vertical grid. The complicated three dimensional grid display can than be refreshed at a lower frequency. The efficiently calculated two dimensional vertical grid display can be refreshed more frequently. As a result, an accurate estimation of height information for objects in a vehicle environment can nearly take place in real time.

In a preferred embodiment, the evaluation unit is designed to detect a road surface as a reference plane. In particular, it is possible to approximate the course of a road surface with a plane. A plane can be efficiently depicted. The use of a plane results in satisfactorily precise prediction results at close range. By simplifying the model in the form of a plane, the refreshing rate can be increased.

In another advantageous embodiment, the plotting unit is designed to calculate the two dimensional vertical grid display with two planes. A grid cell of a first plane comprises an unoccupied height in relation to the reference plane. A grid cell in a second plane comprises an object height in relation to the reference plane. The vertical grid display comprises two datum for each grid cell. Firstly, a height of an object above a reference plane is defined (object height), and secondly, an unoccupied height is defined, in particular when there are no objects on the reference plane. An improved perception of objects in a vehicle environment is obtained in this manner.

In another advantageous embodiment, the grid unit is configured to estimate a movement of the vehicle based on the vehicle sensor data and the environment sensor data. The grid unit is also designed to allocate the environment sensor data to grid cells in the three dimensional grid display based on a compensation for the estimated movement. The vehicle moves. The movement of the vehicle can be detected by means of the vehicle sensors. In order to be able to use environment sensor data acquired by the environment sensors on a vehicle while the vehicle is moving to present an overall view of the environment, the movement of the vehicle is compensated for in plotting these data on the three dimensional grid display. As a result, a three dimensional grid display can be generated with a high data content. Data are analyzed over a longer time period. The precision in determining height information is improved.

In another advantageous embodiment, the input interface is configured to receive radar data from a radar sensor and/or lidar data from a lidar sensor. The grid unit is also configured to generate a three dimensional grid display based on the radar data and/or lidar data. The use of radar and/or lidar data for generating a three dimensional grid display is advantageous. A three dimensional grid of a vehicle environment can be generated using such data. It is possible to record sufficiently precise information regarding a region up to a distance of many hundreds of meters. It is to be understood that a combination of both radar and lidar, or other data sources, can also be used. A precise mapping of the environment is obtained. As a result, a precise estimation of the heights of objects in a vehicle environment can be obtained.

In another advantageous embodiment, a calculation frequency of the evaluation unit and/or the plotting unit is higher than a calculating frequency of the grid unit. A calculating frequency corresponds to a refreshing rate in this regard. The complexity of calculating the three dimensional grid display is substantially greater than the complexity of calculating the two dimensional vertical grid display and/or detecting the reference plane. By using a higher calculating frequency, a higher precision in estimating height information can be obtained, in particular at close range. As a result, it is not necessary to recalculate the three dimensional grid display each time. There is a savings in resources, and the refreshing frequency is increased.

In another advantageous embodiment, the grid unit is configured to estimate a trajectory of a moving object in the three dimensional grid display. The evaluation unit is furthermore configured to detect the reference plane based on the estimated trajectory. A moving object, e.g. another vehicle or a pedestrian, normally moves on the reference plane. By observing and following a moving object, further information regarding the course of the reference plane can be obtained. A trajectory, i.e. a movement of the moving object, is estimated or traced. This estimated trajectory is used in detecting the reference plane. As a result, the precision of the calculation is improved, and the calculating speed is increased.

In another advantageous embodiment, the evaluation unit is configured to detect the reference plane based on the environment sensor data. It is possible that current environment sensor data are also incorporated in the calculation of the reference plane, in addition to taking the three dimensional grid display into account. As a result, the refreshing frequency in detecting the reference plane can again be increased. The precision of the calculation of height information for objects is increased in this manner.

In another advantageous embodiment, the input interface is configured to receive map data for the environment. The evaluation unit is also configured to detect the reference plane based on the map data. It is possible to also take a predefined model of the environment into account, in addition to the map data. As a result, the precision in detecting the reference plane can be further increased. By way of example, map data can be received from a corresponding cloud system via a communication interface. By also taking the further, predefined map data into account, the precision of the height calculation can be further improved.

In another embodiment, the input interface is configured to receive a two dimensional reference grid, generated on the basis of the environment sensor data from other vehicles. The evaluation unit is also configured to detect the reference plane based on the reference grid. Additional data received from other vehicles are taken into account. A two dimensional reference grid corresponds to a two dimensional vertical grid display for another vehicle and based on other environment sensor data. As a result, the precision of the calculation of the height information can be further improved. In particular, it is advantageous when the environment sensor data from the other vehicles are likewise present in an absolute coordinate system. A corresponding transformation can also be carried out.

It is also advantageous that the evaluation unit is configured to calculate a position of the vehicle within the three dimensional grid display. The evaluation unit is also configured to detect the reference plane based on the actual position of the vehicle. It can also be used such that the actual position of the vehicle normally corresponds to a position on the reference plane, i.e. the road. By also taking this model information into account, the precision of the calculation of the height information can be improved.

The system according to the invention can be integrated in a vehicle, by way of example. Optionally and advantageously, the system according to the invention can comprise a radar, lidar, ultrasound, and/or camera serving as the environment sensor. The system can also comprise an inertia sensor, preferably an inertia sensor unit containing acceleration and rotational rate sensors, and/or a position sensor, preferably a GPS, Galileo, or GLONASS sensor. It is to be understood that the environment sensor can comprise various sensors, such that data fusion can take place.

An object is understood to be a stationary or moving object. By way of example, trees, houses, other vehicles, pedestrians, animals, bridges and roads represent objects. A vehicle environment comprises a region of the vehicle that can be perceived, in particular by an environment sensor mounted on the vehicle. An environment sensor can also comprise numerous sensors, which enable a 360° view and can thus display a complete environment image. Numerous scanning points are normally generated during a scanning cycle of an environment sensor. A scanning cycle of an environment sensor is understood to be a single scanning of the visible region. The sensor data recorded in a scanning cycle can be referred to as a target list (Target List). A grid display is understood to be a display in the form of a grid, in which various scanning points, in particular, are plotted on cells of the grid based on their detected positions. A three dimensional grid, or a three dimensional grid display therefore corresponds to a three dimension model of the environment. The three dimensional grid display in this case is a display in reference to a fixed vehicle coordinate system. The two dimensional vertical grid display corresponds to a two dimensional model of a vehicle environment, wherein each grid cell comprises information regarding an object height and/or an unoccupied height for an object located in the corresponding position in the two dimensional display. The two dimensional vertical grid display corresponds herein to a preferably stationary coordinate system (global coordinate system) in relation to a road or ground surface. A detection of a reference plane is understood to be a calculation based on different algorithms. A ground surface, in particular a road surface, is calculated or estimated on the basis of the sensor points of the vehicle environment recorded in the three dimensional grid display.

### BRIEF DESCRIPTION OF THE DRAWINGS

The invention shall be described and explained in greater detail below based on some selected exemplary embodiments in conjunction with the attached drawings. Therein:

FIG. 1 shows a schematic illustration of a vehicle that has a system according to the invention in an exemplary environment;

FIG. 2 shows a schematic illustration of a device according to the invention for determining height information;

FIG. 3 shows a schematic illustration of the vehicle environment in a side view;

FIG. 4 shows a schematic illustration of the model of the vehicle environment in a side view;

FIG. 5 shows a schematic illustration of the detection of an unoccupied height;

FIG. 6 shows a schematic illustration of a vehicle that has a system according to the invention, and different sensors; and

FIG. 7 shows a schematic illustration of a method according to the invention.

### DETAILED DESCRIPTION

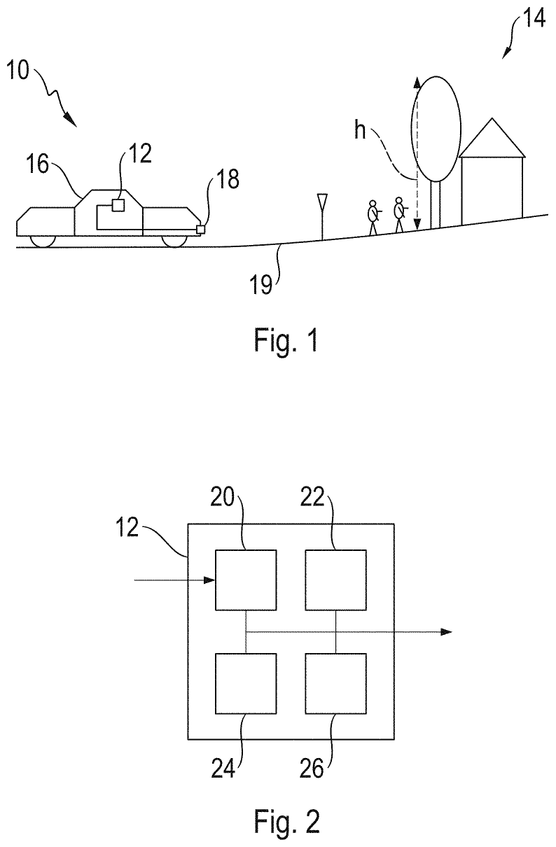

FIG. 1 shows a schematic illustration of a system 10 according to the invention. The system 10 comprises a device 12 for determining height information for an object 14 in a vehicle 16 environment. The environment is recorded by means of an environment sensor 18. The environment comprises various objects (trees, houses, traffic signs, other road users, pedestrians, bicyclists, animals, roads, etc.). These various objects can be detected by means of the environment sensor 18. By way of example, the objects reflect radar waves from a radar sensor, or can be detected via a lidar sensor.

The system 10 according to the invention allows height information for the objects in the vehicle environment to be determined. The detection of objects 14 first takes place in a fixed vehicle coordinate system for the environment sensor. In order to determine height information based thereon, e.g. a height h of an object 14, a reference plane 19 must first be determined (corresponding to a ground or road surface) in relation to the height h. In order to be able to determine height information, a position or course of the reference plane 19 must be known.

In the illustrated exemplary embodiment, the device 12 and the environment sensor 18 are integrated in the vehicle 16. It is to be understood that other positions of the device and the environment sensor are conceivable in other embodiments. In particular, the device 12 can also be located partially or entirely outside the vehicle, e.g. in the form of a cloud service or a mobile device with a corresponding app.

The device 12 according to the invention is schematically illustrated in FIG. 2. The device 12 comprises an input interface 20, a grid unit 22, an evaluation unit 24, and a plotting unit 26. The various units can be designed in particular as processors, processor modules, or software for a processor. The device according to the invention can be implemented in part or entirely in software and/or hardware. By way of example, the device 12 can be integrated in a vehicle control unit, or it can be implemented as a separate module.

Sensor data from an environment sensor and sensor data from a vehicle sensor are received via the input interface 20. The input interface 20 can be implemented as a hardware plug-in connection, for example. It is also possible for the input interface 20 to be configured as a corresponding software interface for receiving data. The environment sensor data comprise information regarding objects in the vehicle environment. In particular, information regarding the positions of various objects is received. Preferably, radar and/or lidar sensor data are received and processed. The data from such sensors contain information regarding a spatial position of a detected target, or location, at which an electromagnetic wave is reflected. In particular, individual scanning points are received. By way of example, a few hundred to numerous thousand scanning points can be generated in a scanning cycle of an environment sensor. Normally, numerous scanning cycles are carried out per second. A scanning frequency can be 16 Hz to 18 Hz.

A three dimensional grid display of the vehicle environment is first generated in the grid unit 22 in a fixed vehicle coordinate system. The individual scanning points of the environment sensor are plotted on a discrete three dimensional grid. In particular, a grid with a uniform edge length of the individual cells can be used. The number of scanning points plotted in each cell is then recorded for these cells, or the regions of these cells.

The vehicle continues to move while acquiring the environment sensor data. As a result, the relationships of environment sensor data change, because the environment sensor is connected to the vehicle in a fixed manner. The same object is recorded at a different relative position. In order to be able to plot sensor data from numerous scanning cycles taking place when the vehicle, or vehicle sensor, is in different positions, the movement of the vehicle must be compensated for. The vehicle sensor data received via the input interface 20 are used for this. In particular, inertia sensor data, e.g. accelerations, rotational rates, etc. can be used. It is also possible to use data from a position sensor.

By taking environment sensor data and vehicle sensor data into account, the three dimensional grid display of the environment can be generated over a longer time periods. In particular the prior content of the grid display can be transferred to other grid cells via an estimation of the movement of the vehicle.

The course of the reference plane is detected or estimated in the evaluation unit 24, based on the previously generated three dimensional grid display. There are different standard approaches for detecting the course of the road or ground surface (road plane estimation) based on data from different environment sensors. For this, it is possible to take into account sensor data from the environment sensor and/or the vehicle sensor, in addition to the three dimensional grid display, in order to obtain greater precision. The reference plane is detected inside the three dimensional grid display in this regard.

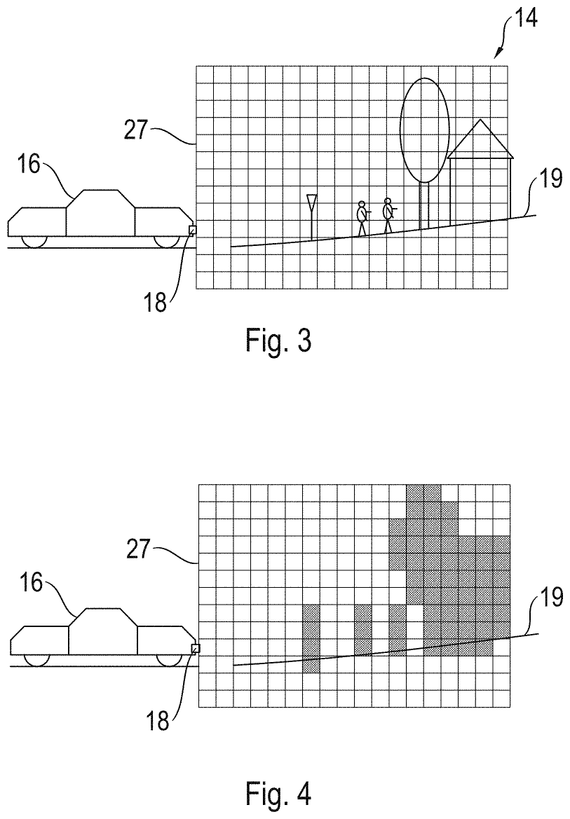

The functioning of the plotting unit 26 is schematically illustrated in FIGS. 3 and 4. Both figures show a schematic side view of the recorded environment and the corresponding cells of the three dimensional grid display 27. The extension of the three dimensional grid display along the x-axis (direction of travel for the vehicle) and the z-axis (vertical) is shown in the illustration. It is to be understood that the grid display also has an extension along the y-axis (not shown, corresponding to a direction perpendicular to the illustration plane in FIGS. 3 and 4). The three dimensional grid display 27 normally has a fixed and uniform resolution along the x, y, and z axes. The three dimensional grid display 27 corresponds to a discrete depiction of the environment. Based on an estimation of the movement of the vehicle, the newly arriving data from the environment sensor are always plotted in the correct cells.

The vehicle perceives the objects 14 in the environment by means of the environment sensor. First, the reference plane 19 is determined. Preferably, a plane in three dimensional space is used as the model for the reference plane 19 (described by the model point and the norm vector). The heights of objects above the reference plane 19 can then be determined based on the reference plane and the three dimensional grid display.

A two dimensional vertical grid display of the vehicle environment is generated in the plotting unit 26, in which each cell of a two dimensional grid comprises height information assigned to the corresponding position. This height information (object height or unoccupied height) corresponds to the height of an object in relation to the reference plane 19. The x and y axes of the two dimensional grid display preferably correspond in this regard to the x and y axes of the three dimensional grid display.

The information regarding the heights of individual objects are combined to form a value. As a result, the dimensionality of the three dimensional grid display can be reduced. By using the two dimensional grid display, a substantial improvement in the calculability is obtained. This allows for a higher refreshing rate, such that the heights of objects in a vehicle 16 environment can basically be detected in real time. The estimation of the reference plane 19 improves as the vehicle approaches the relevant region due to the sensor precision. According to the invention, this improved calculation is used iteratively to improve the estimation of object heights or the estimation of whether it is possible to pass under and/or drive over an object. The improved estimation can be obtained by using the two dimensional grid display without having to recalculate the three dimensional grid display. Computing time is reduced. In particular, by refreshing the calculation of the two dimensional grid display, the cycle times for the environment sensor and the vehicle sensor are not exceeded, such that new sensor data can be used in each time increment.

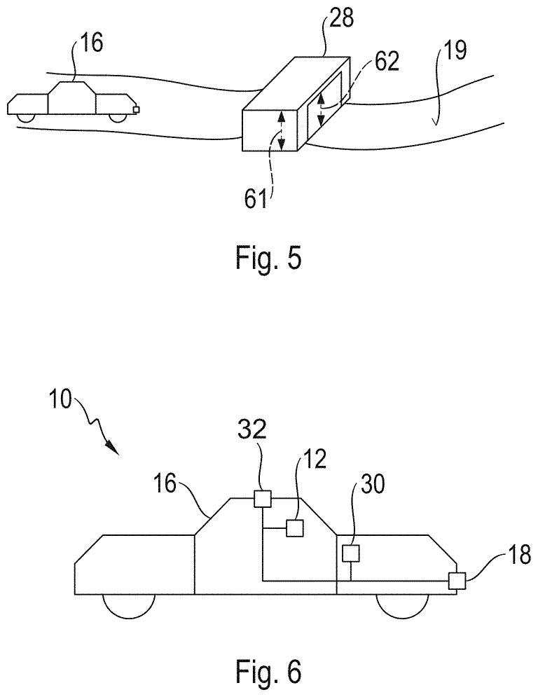

In addition to, or as an alternative to the calculation and estimation of object heights in the vehicle environment, unoccupied heights can also be calculated as height information. A vehicle 16 approaching a bridge 28 is shown in FIG. 5. As explained above, an object height b1 is first determined for the bridge supports, and plotted in the corresponding grid cells of the two dimensional vertical grid display. It is then possible to determine an unoccupied height b2, in addition to or as an alternative to determining the object heights of individual objects, which is then plotted in a second plane in the two dimensional grid display. In the example shown here, there is an unoccupied height b2 below the bridge, corresponding to a height through which a vehicle can pass. This unoccupied height b2 is also in relation to the reference plane 19, and corresponds in this regard to a height information for a vehicle passing under the bridge, which is calculated in a manner analogous to that for the object height b1. According to the invention, an object height and/or an unoccupied height can be plotted in the two dimensional grid display. Two values (object height and unoccupied height) may be calculated for each two dimensional position, i.e. for each grid cell.

It is possible for an autonomous or semi-autonomous vehicle to make a decision regarding whether the vehicle can pass under a bridge or a low-hanging branch from a tree based on the information relating to the unoccupied height.

Both the precision of the object height determination as well as the precision of the determination of the unoccupied height ideally correspond to one half of a cell size. Error propagation can occur, however, due to imprecisions in estimating the movement of the vehicle in question, resulting in greater errors.

Additional information can be used for estimating the reference plane 19. By way of example, a course of the reference plane can be estimated from an examination of a trajectory and an estimation of the movement of moving objects. The fundamental understanding of the model represents the information in this regard, that moving objects normally move on the ground surface. It is also possible to use map data. It is likewise possible to use information from a cloud system (e.g. an internet-based service). In particular, information based on sensor data from other road users, e.g. other vehicles, can be used. The exchange can take place via a corresponding communications system and a corresponding cloud server. It is also possible to use a localization of the vehicle in question, e.g. through a simultaneous localization and mapping process, for the improvement of the estimation of the reference plane.

A vehicle 16 is schematically illustrated in FIG. 6, in which a system 10 according to the invention is integrated. The system 10 according to the invention comprises an environment sensor 18, a device 12, a vehicle sensor, with an inertia sensor 30, and a position sensor 32. The vehicle sensor can also comprise just one of the two sensors. The position sensor can correspond to, e.g., a GPS, Galileo, or GLONASS sensor. The device 12 can be integrated in a vehicle control unit, for example. In particular, it is possible to process data from sensors already existing on the vehicle in the device 12.

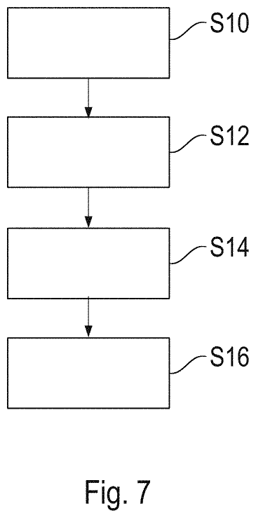

A method according to the invention for determining height information of an object in a vehicle environment is schematically illustrated in FIG. 7. The method comprises steps for receiving environment sensor data S10, generating a three dimensional grid display S12, detecting a reference plane S14, and calculating a two dimensional vertical grid display S16. The method according to the invention can be executed in the form of a smartphone app, or software for a vehicle control unit. The first step S10 for generating a three dimensional grid display is carried out in an absolute vehicle coordinate system, wherein the generated three dimensional grid display is stationary in relation to this absolute vehicle coordinate system. The next steps S14 and S16 for detecting and calculating, respectively, are carried out in a global coordinate system, which is not stationary in relation to the complete range of the sensors normally used in a vehicle. In particular, the ground or road surface is used as the reference point.

It is possible according to the invention to decide whether a region formed by a grid cell in the two dimensional vertical grid display can be passed under or over based on the determined two dimensional vertical grid display and on prior knowledge regarding the height of the vehicle in question. In particular, grid cells, or the environment regions assigned thereto, can be driven over when the object height is zero. With regard to unoccupied heights, regions can be passed under that have an unoccupied height that is greater than the height of the vehicle in question.

The invention has been comprehensively described and explained in reference to the drawings in the description. The description and explanations are to be regarded by way of example, and not in a limiting manner. The invention is not limited to the disclosed embodiments. Other embodiments or variations can be derived by the person skilled in the art in using the present invention and with a precise analysis of the drawings, the disclosure, and the following claims.

The terms “comprising” and “containing” in the claims do not exclude the presence of further elements or steps. The indefinite article “a” or “an” does not exclude the presence of a plurality. A single element or a single unit can execute the functions of numerous units specified in the claims. An element, unit, interface, device and system can be partially or entirely implemented as hardware and/or software. The mere mention of some measures in various dependent claims is not to be understood to mean that a combination of these measures cannot likewise be used advantageously. A computer program can be stored/run on a non-volatile data medium, e.g. on an optical memory or a solid state drive (SSD). A computer program can be run with hardware and/or as part of a hardware, e.g. by means of the internet or hard-wired or wireless communications systems. Reference symbols in the claims are not to be understood as limiting.

### REFERENCE SYMBOLS

10 system
12 device
14 object
16 vehicle
18 environment sensor
19 reference plane
20 input interface
22 grid unit
24 evaluation unit
26 plotting unit
27 three dimensional grid display
28 bridge
30 inertia sensor
32 position sensor

1. A device for determining height information of an object in a vehicle environment, the device comprising:
an input interface configured to receive environment sensor data from an environment sensor, the environment sensor data containing information regarding an object in the vehicle environment, and receive vehicle sensor data from a vehicle sensor, the vehicle sensor data containing information regarding a movement of the vehicle in relation to the vehicle environment;
a grid unit configured to generate a three dimensional grid display of the vehicle environment based on the environment sensor data and vehicle sensor data;
an evaluation unit configured to detect a reference plane in the three dimensional grid display; and
a plotting unit configured to calculate a two dimensional vertical grid display of the vehicle environment based on the three dimensional grid display and the reference plane, wherein a grid cell in the two dimensional vertical grid display comprises height information for the object in relation to the reference plane.

2. The device according to claim 1, wherein the evaluation unit is configured to detect a road surface as the reference plane.

3. The device according claim 1, wherein the plotting unit is configured to calculate the two dimensional vertical grid display with two planes, and wherein a grid cell in a first plane comprises an unoccupied height in relation to the reference plane, and wherein a grid cell in a second plane comprises an object height in relation to the reference plane.

4. The device according to claim 1, wherein the grid unit is configured to:
estimate an estimated movement of the vehicle based on the vehicle sensor data and the environment sensor data; and
plot the environment sensor data on grid cells in the three dimensional grid display based on a compensation for the estimated movement.

5. The device according to claim 1, wherein the input interface is configured to receive at least one of radar data from a radar sensor or lidar data from a lidar sensor, and the grid unit is configured to generate the three dimensional grid display based on the at least one of the radar data or the lidar data.

6. The device according to claim 1, wherein a calculating frequency of at least one of the evaluation unit or the plotting unit is higher than a calculating frequency of the grid unit.

7. The device according to claim 1, wherein the grid unit is configured to estimate a trajectory of a moving object in the three dimensional grid display, and wherein the evaluation unit is configured to detect the reference plane based on the estimated trajectory.

8. The device according to claim 1, wherein the evaluation unit is configured to detect the reference plane based on the environment sensor data.

9. The device according to claim 1, wherein the input interface is configured to receive map data for the environment, and wherein the evaluation unit is configured to detect the reference plane based on the map data.

10. The device according to claim 1, wherein the input interface is configured to receive a two dimensional reference grid generated on the basis of environment sensor data from other vehicles, and wherein the evaluation unit is configured to detect the reference plane based on the reference grid.

11. The device according to claim 1, wherein the evaluation unit is configured to calculate a position of the vehicle in the three dimensional grid display and to detect the reference plane based on the this position.

12. A system for determining height information for the object in the vehicle environment, the system comprising:
the device according to claim 1;
the environment sensor configured to detect the object in the vehicle environment; and
the vehicle sensor configured to detect the movement of the vehicle in relation to the vehicle environment.

13. The system according to claim 12, wherein the environment sensor comprises at least one of a radar sensor, a lidar sensor, an ultrasound sensor, or a camera, and wherein the vehicle sensor comprises at least one of an inertia sensor or a position sensor.

14. A method for determining height information for an object in a vehicle environment, the method comprising:
receiving, by an input interface, environment sensor data from an environment sensor, the environment sensor data containing information regarding objects in the vehicle environment;
receiving, by the input interface, vehicle sensor data from a vehicle sensor, the vehicle sensor data containing information regarding a movement of the vehicle in relation to the vehicle environment;
generating, by a grid unit, a three dimensional grid display of the vehicle environment based on the environment sensor data and the vehicle sensor data;
detecting, by an evaluation unit, a reference plane in the three dimensional grid display; and
calculating, by a plotting unit, a two dimensional vertical grid display of the vehicle environment based on the three dimensional grid display and the reference plane, wherein a grid cell of the two dimensional vertical grid display comprises height information for the object in relation to the reference plane.

15. A computer program product containing program code stored thereon that, when executed by a computer, cause the computer to perform the following:
receive environment sensor data from an environment sensor, the environment sensor data containing information regarding objects in a vehicle environment;
receive vehicle sensor data from a vehicle sensor, the vehicle sensor data containing information regarding a movement of the vehicle in relation to the vehicle environment;
generate a three dimensional grid display of the vehicle environment based on the environment sensor data and the vehicle sensor data;
detect a reference plane in the three dimensional grid display; and
calculate a two dimensional vertical grid display of the vehicle environment based on the three dimensional grid display and the reference plane, wherein a grid cell of the two dimensional vertical grid display comprises height information for the object in relation to the reference plane.

16. The method of claim 14, further comprising:
detecting, by the evaluation unit, a road surface as the reference plane.

17. The method of claim 14, further comprising:
calculating, by the plotting unit, the two dimensional vertical grid display with two planes, wherein a grid cell in a first plane comprises an unoccupied height in relation to the reference plane, and wherein a grid cell in a second plane comprises an object height in relation to the reference plane.

18. The method of claim 14, further comprising:
estimating, by the grid unit, an estimated movement of the vehicle based on the vehicle sensor data and the environment sensor data; and
plotting, by the grid unit, the environment sensor data on grid cells in the three dimensional grid display based on a compensation for the estimated movement.

19. The method of claim 14, further comprising:
estimating, by the grid unit, an estimated trajectory of a moving object in the three dimensional grid display; and
detecting, by the evaluation unit, the reference plane based on the estimated trajectory.

20. The method of claim 14, further comprising:
receiving, by the input interface, map data for the vehicle environment; and
detecting, by the evaluation unit, the reference plane based on the map data.
